(19) United States
(12) Patent Application Publication
(10) Pub. No.: US 2026/0310136 A1
(43) Pub. Date: Oct. 8, 2026

(54) ZERO-FREE MOD TIME TRACKING SYSTEM

(71) Applicants: Bo Payne, College Grove, TN (US); Nathan Reeve, Cypress, TX (US)

(72) Inventors: Bo Payne, College Grove, TN (US); Nathan Reeve, Cypress, TX (US)

(21) Appl. No.: 19/172,766

(22) Filed: Apr. 8, 2025

(51) Int. Cl. G04C 3/16; G04B 13/02; G04C 3/02

(52) U.S. Cl. CPC G04C 3/16; G04B 13/02; G04C 3/02

(57) ABSTRACT

The present invention is directed to a zero-free MOD time tracking system that is capable of eliminating zero-based anomalies in modular arithmetic, ensuring synchronization across multiple time scales. More specifically, the invention uses integer-based scaling ratios to maintain perfect synchronization in both physical and digital timekeeping devices. The zero-free MOD time tracking system is mathematically perfect comprising a self-synchronization structure that eliminates inefficiencies.

### FIELD OF THE INVENTION

The present invention is directed to a zero-free MOD time tracking system that is capable of eliminating zero-based anomalies in modular arithmetic, ensuring synchronization across multiple time scales. More specifically, the invention uses integer-based scaling ratios to maintain perfect synchronization in both physical and digital timekeeping devices.

### BACKGROUND OF THE INVENTION

Traditional time structures, for example, 60 seconds per minute or 24 hours per day, are arbitrary human creations, leading to inefficient calculations, inconsistencies, and synchronization problems. In algorithms, zero is a placeholder used for positional notation.

In traditional timekeeping, common errors arise due to the nature of modular arithmetic which relies on a {0, 1, . . . , n−1} structure. These errors include division by zero, undefined states, rounding errors, and synchronization drift. The problem of synchronization drift occurs when the timekeeping apparatus loses accuracy over time which requires the timekeeping apparatus to need manual correction and recalibration.

Computational time systems rely on floating-point arithmetic, which introduces rounding errors that accumulate over long periods, impacting accuracy in high-precision fields.

Traditional clocks require complex gear trains, phase adjustments, and corrective mechanisms to synchronize time across different scales. These conventional clocks have gear systems that often introduce backlash and errors due to tiny tolerances in each stage.

Therefore, there exists a need for a zero-free MOD time tracking system that uses an alternative time standard that offers enhanced precision and efficiency for scientific, financial, and technological applications. The zero-free MOD time tracking system is capable of optimizing digital timing for applications such as high-frequency trading, cryptographic timestamps, and AI scheduling.

### SUMMARY OF THE INVENTION

The present invention is directed to a zero-free MOD time tracking system that is capable of eliminating zero-based anomalies in modular arithmetic, ensuring synchronization across multiple time scales. More specifically, the invention uses integer-based scaling ratios to maintain perfect synchronization in both physical and digital timekeeping devices.

The zero-free MOD time tracking system is mathematically perfect comprising a self-synchronization structure that eliminates inefficiencies.

Common modular arithmetic errors can be eliminated by adjusting the range of the structure {1, 2, . . . , n} creating a zero-free modular system eliminating zero-based anomalies and rounding errors while providing consistent scaling across all time units.

In an exemplary embodiment, the zero-free MOD time tracking system for using in time keeping devices comprises a power source, an escapement mechanism, a plurality of cycloidal gears, and a gear train housing.

In one embodiment, the zero-free MOD time tracking system further comprises a mod-9 synchronization mechanism. In another embodiment, the zero-free MOD time tracking system further comprises a piezoelectric actuator.

In one embodiment, the power source comprises a main spring. In yet another embodiment, the escapement mechanism comprises a single oscillatory mechanism capable of consistently powering entire time keeping device without extra correction linkages or separate oscillators.

In another embodiment, the escapement mechanism comprises a balance wheel, a pendulum, a fluidic oscillator, a magnetically ratcheted gear capable of oscillating at a stable rate, or any combination thereof.

In one embodiment, the plurality of cycloidal gears comprises specially shaped gears with integer-based tooth ratios. In yet another embodiment, the plurality of cycloidal gears comprises magnetic ratcheting gears capable of magnetically engaging gears with integer-based tooth ratios. In one embodiment, the plurality of cycloidal gears comprises a tooth ratio of mod 9.

In yet another embodiment, the plurality of cycloidal gears is capable of transferring oscillatory pulses from the escapement mechanism to separate stages of time (e.g., seconds, minutes, hours) without introducing fractional steps.

In one embodiment, the gear train housing comprises a rigid structure capable of supporting and aligning each axle in the plurality of cycloidal gears, ensuring minimal friction and precise mesh. In another embodiment, the plurality of cycloidal gears comprises 6 distinct gears: (1) 6 T gear, comprising a fine-tuned correctional gear capable of fractional steps when correction is needed; (2) 18 T gear, wherein the 18 T gear is capable of handling small cycle adjustments; (3) 27 T gear, wherein the 27 T gear is capable of linking to hour based scaling; (4) 54 T gear, wherein the 54 T gear is capable of bridging hours to larger cycles; (5) 81 T gear, wherein the 81 T gear is capable of defining day-based synchronization; and (6) 162 T gear, wherein the 162 T gear is capable of extending to larger TTS cycles.

In an exemplary embodiment, the material of construction for the plurality of cycloidal gears comprises titanium, carbon fiber, advanced metal alloys, Inconel, Monel, cobalt-chromium alloys, titanium alloys, zirconia, silicon nitride, aluminum oxide, high-performance thermoplastics, self-lubricating plastics, ZR-based bulk metallic glass, or any combination thereof; for the piezoelectric actuator comprises quartz crystal, high-performance thermoplastics, ZR-based bulk metallic glass, or any combination thereof; and for the gear housing comprises aluminum alloy, advanced metal alloys, Inconel, Monel, cobalt-chromium alloys, titanium alloys, zirconia, silicon nitride, aluminum oxide, carbon fiber reinforced polymers, high-performance thermoplastics, self-lubricating plastics, ZR-based bulk metallic glass, or any combination thereof.

In an alternate embodiment, the material of construction for the plurality of magnetic ratcheting gears comprises neodymium magnets, steel, advanced metal alloys, Inconel, Monel, cobalt-chromium alloys, titanium alloys, zirconia, silicon nitride, aluminum oxide, high-performance thermoplastics, self-lubricating plastics, ZR-based bulk metallic glass, or any combination thereof.

In one embodiment, the method of construction for the zero-free MOD time tracking system comprises CNC machining, precision casting, thin-film deposition, die casting, or any combination thereof.

In yet another embodiment, the zero-free MOD time tracking system comprises stacked gear modulation allowing gears to synchronize in a nested modular hierarchy.

In one embodiment, the escapement mechanism is capable of maintaining a stable integer beat rate across all time intervals, e.g. 19,440 beats per hour or 25,920 beats per hour.

In another embodiment, the gear train comprises the scaling of each gear step, G=9n, wherein each gear level comprises a teeth ratio using a modular value based on the base 9 system.

In an exemplary embodiment, the mod-9 synchronization mechanism cycles through a perfect, repeating pattern comprising the following steps: (1) applying power to input, (2) moving power to the main spring, (3) moving power to mod-9 gear stage 1 comprising a ratio of 9:1 for the seconds cycle, (4) moving power to mod-9 gear stage 2 comprising a ratio of 81:9 for the minutes cycle, and (5) moving power to mod-9 gear stage 3 comprising a ratio of 729:81 for the hours cycle.

In another embodiment, the zero-free MOD time tracking system for using in time keeping devices, comprises a plurality of MEMS gears, a magnetic ratcheting layer, and a micro-oscillation driver.

In one embodiment, the material of construction for the plurality of MEMS gears comprises silicon, doped silicon or poly-silicon, silicon carbide or silicon-germanium, synthetic diamond, high-entropy alloys, or any combination thereof; for the magnetic ratcheting layer comprises graphene-coated conductors; and for the micro-oscillation driver comprises piezoelectric film.

In an embodiment, the method of construction for the zero-free MOD time tracking system comprises lithography, vapor deposition, MEMS fabrication, or any combination thereof.

In one embodiment, the zero-free MOD time tracking system comprises stacked gear modulation allowing gears to synchronize in a nested modular hierarchy.

In yet another embodiment, the zero-free MOD time tracking system comprises an oscillatory compensation system wherein self-correcting oscillation maintains timing after interference from outside forces.

In an alternated embodiment, the zero-free MOD time tracking system further comprises integer-based time modulation with fractal digital roots comprising the following steps: (1) starting; (2) initializing piezo/magnetic oscillator; (3) checking beat rate; (4) finding the beat rate is IN Mod-9 Cycle comprises the following sub steps: passing a time pulse, updating the display, and continuing to next the cycle; (5) finding the beat rate is NOT IN Mod-9 Cycle comprises the following sub steps: auto-correcting drift, adjusting the oscillation, and correcting the Mod-9 cycle.

In one embodiment, the zero-free MOD time tracking system comprises the following steps: (1) starting, (2) initializing time tracking system timestamp engine, (3) syncing with integer-only timekeeping, (4) generating fractal digital root time stamps, (5) applying Mod-9 scaling to all time stamps, and (6) displaying universal zero-free time.

In another embodiment, the zero-free MOD time tracking system further comprises an auto-correction system comprising the following steps: (1) detecting an external force disturbance, (2) detecting phase shift, (3) applying nested Mod-9 sync algorithm, (4) correcting beat rate with no floating-point drift, and (5) updating time output.

In an embodiment, the escapement mechanism is capable of maintaining a stable integer beat rate across all time intervals, e.g. 19,440 beats per hour or 25,920 beats per hour. In yet another embodiment, the gear train comprises the scaling of each gear step, G=9n, wherein each gear level comprises a teeth ratio using a modular value based on the base 9 system.

Various objects, features, aspects, and advantages of the inventive subject matter will become more apparent from the following detailed description of exemplary embodiments, along with the accompanying figures in which like numerals represent like components.

### BRIEF DESCRIPTION OF DRAWINGS

FIG. 1 depicts a table of an exemplary embodiment of the gear train ratio in the zero-free MOD time tracking system.

FIG. 2 depicts a flow chart of an exemplary embodiment of the mod-9 synchronization mechanism.

FIG. 3 depicts a flow chart of an exemplary embodiment of the integer-based time modulation with fractal digital roots.

FIG. 4 depicts a flow chart of an exemplary embodiment of the digital functionality in the zero-free MOD time tracking system.

FIG. 5 depicts a flow chart of an exemplary embodiment of the auto-correction system for the zero-free MOD time tracking system.

FIG. 6 depicts the front view of an exemplary embodiment of a plurality of cycloidal gears in the zero-free MOD time tracking system.

FIG. 7 depicts the side view of an exemplary embodiment of a plurality of cycloidal gears in the zero-free MOD time tracking system.

FIG. 8A depicts a graph showing the escapement mechanism stability in the zero-free MOD time tracking system and the stability in a traditional escapement mechanism.

FIG. 8B depicts a graph comparing the phase drift in traditional phase locking and the phase locking in the zero-free MOD time tracking system.

FIG. 9A depicts a graph comparing the timekeeping stability in a fluidic oscillator and a balance wheel.

FIG. 9B depicts a graph comparing the timestamp accuracy over time between the zero-free MOD time tracking system and a traditional timekeeping system.

FIG. 10A depicts a bar graph comparing the synchronization latency between the zero-free MOD time tracking system and a network time protocol (NTP).

FIG. 10B depicts a graph showing the self-correction efficiency in the zero-free MOD time tracking system.

FIG. 11 depicts a table showing the modular representation in an exemplary embodiment of the zero-free MOD time tracking system.

FIG. 12 depicts a sample of the software code used in validating an exemplary embodiment of a zero-free MOD time tracking system.

FIG. 13 depicts a sample of the software code used in validating an exemplary embodiment of a zero-free MOD time tracking system.

### DETAILED DESCRIPTION OF THE INVENTION

The following description is not an admission that any of the information provided herein is prior art or relevant to the present invention, or that any publication specifically or implicitly referenced is prior art. Any publications cited in this description are incorporated by reference herein. Where a definition or use of a term is an incorporated reference is inconsistent or contrary to the definition of that term provided herein, the definition of that term provided herein applies and the definition of that term in the reference does not apply.

As used in the description herein and throughout the claims that follow, the meaning of “a,” “an,” and “the” includes plural reference unless the context clearly dictates otherwise. Also, as used in the description herein, the meaning of “in” includes “into” and “on” unless the context clearly dictates otherwise.

As used herein, the term “about” in conjunction with a numeral refers to a range of that numeral starting from 10% below the absolute value of the numeral to 10% above the absolute value of the numeral, inclusive.

As used herein, the terms “microelectromechanical system” and “MEMS” are used interchangeably throughout the disclosure.

As used herein, the terms “zero-free MOD time tracking system,” “time tracking system” and “TTS” are used interchangeably throughout the disclosure.

The present invention is directed to a zero-free MOD time tracking system that is capable of eliminating zero-based anomalies in modular arithmetic, ensuring synchronization across multiple time scales. More specifically, the invention uses integer-based scaling ratios to maintain perfect synchronization in both physical and digital timekeeping devices. The zero-free MOD time tracking system uses a unified time structure enabling all time units to align perfectly without requiring external recalibration.

The zero-free MOD time tracking system comprises a single drive mechanism. In mechanical clocks, the escapement mechanism enables the use of a single oscillatory motion to drive the time progression across multiple levels. In digital systems, the fluidic oscillator is capable of maintaining stability across all scales by eliminating the need for error-prone floating-point calculations.

The zero-free MOD time tracking system comprises piezoelectric adjusted micro steps using integer-based scaling ensuring consistency in each level of time measurement. Structured consistent scaling comprises units of 1, 3, 9, 81, 2025, wherein unit 1 is the fundamental time measurement. Each time measurement is capable of being used consistently from microseconds to centuries.

The plurality of cycloidal gears in the zero-free MOD time tracking system engage in a full modular oscillation eliminating the need for fractional steps. In addition, the use of cycloidal engagement eliminates micro-slip. The magnetic ratcheting gears are magnetically gated ensuring the gear train of the zero-free MOD time tracking system can cycle digitally without mechanical friction. The zero-free MOD time tracking system comprises fractal feedback cycles eliminating cumulative error.

In mechanical clocks, the traditional gear is replaced with a simpler self-synchronizing structure. Each gear and/or escapement mechanism comprises TTS ratios ensuring mathematically perfect time progression. Due to this design, each gear stage and/or timing module is capable of naturally keeping itself aligned without requiring external adjustments or complicated correction mechanisms. In addition, this self-synchronizing structure eliminates the need for periodic adjustments because all cycles align naturally and does not require additional levers or external calibrations. Lastly, the zero-free MOD time tracking system is capable of automatic realignment. If any of the mechanism is off beat, the next cycle naturally realigns the overall time scale without user intervention.

The zero-free MOD time tracking system algorithm replaces the use of 0 with 9 for stability, eliminating the entire class of zero-based anomalies that occur in traditional computational time keeping. Using 9 as a stabilizing constant leverages the digital root of large internals aligning to 9. Therefore, resonating with deeper universal patterns. For example, there are 86,400 seconds in a day. The digital root for the seconds on a day can be found by adding each integer until a single integer remains [(8+6+4+0+0=18), (1+8=9)]. Thus, the digital root of 86,400 is 9. The digital root for seconds in a year can be found the same way. There are 31,536,000 seconds in a year [(3+1+5+3+6+0+0+0=18), (1+8=9)]. Thus, the digital root for seconds in a year is 9.

In arithmetic logic, zero-free time tracking system changes “value mod 9=0” to “value mod 9=9” eliminating the entire notion of zero remainder.

The zero-free MOD time tracking system can simulate large timespans (e.g., 1012 seconds, 1029 seconds, millions of years) in a short real-time window without hitting computational meltdown or day-boundary anomalies.

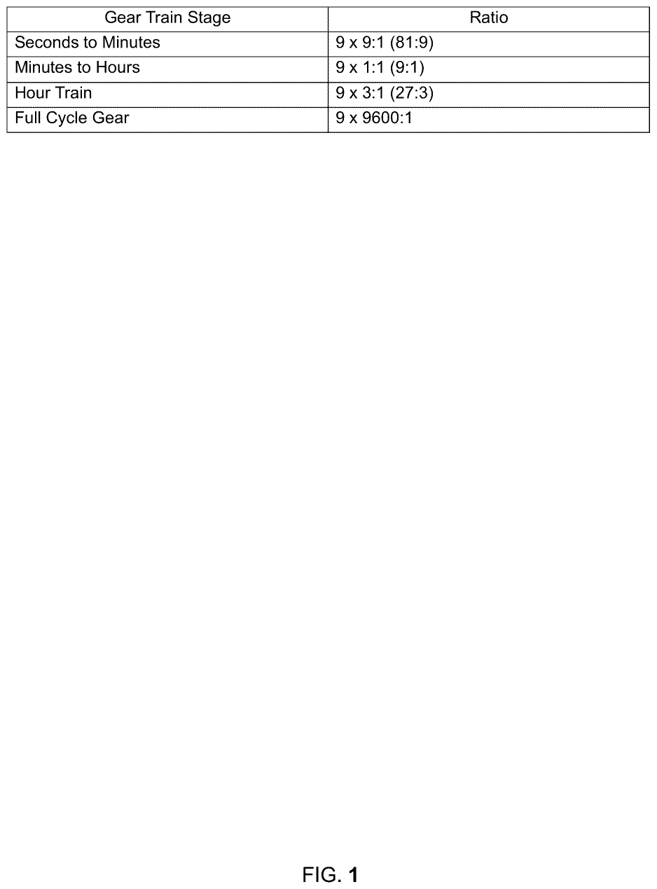

Exemplary configurations of the present invention are depicted in FIGS. 1-13, in which zero-free MOD time tracking system 100 comprises plurality of cycloidal gears 10, plurality of magnetic ratcheting gears 20, mod-9 synchronization mechanism 25, piezoelectric actuator 30, first power supply 35, gear housing 40, and main spring 45.

In an exemplary embodiment, zero-free MOD time tracking system comprises power source 35, escapement mechanism 5, a plurality of cycloidal gears 10, and gear train housing 40.

In an alternate embodiment, power source 35 comprises main spring 45. In this embodiment, main spring 45 provides the initial energy to drive escapement mechanism 5 and plurality of cycloidal gears 10.

In yet another embodiment, main spring 45 is capable of being wound manually. In an alternate embodiment, main spring 45 is capable of being wound by an automatic rotor.

In an exemplary embodiment, escapement mechanism 5 comprises a single oscillatory mechanism that is capable of consistently powering the entire clock without extra correction linkages or separate oscillators.

In an embodiment, escapement mechanism 5 converts the continuous force of main spring 5 into evenly spaced time pulses. In this embodiment, escapement mechanism 5 comprises a balance wheel. In another embodiment, escapement mechanism 5 comprises a pendulum. In yet another embodiment, escapement mechanism 5 comprises a fluidic oscillator. In another embodiment, escapement mechanism 5 comprises a magnetically ratcheted gear capable of oscillating at a stable rate.

In an exemplary embodiment, plurality of cycloidal gears 10 comprise specially shaped gears with integer-based tooth ratios. In an alternate embodiment, plurality of cycloidal gears 10 comprises magnetic ratcheting gears capable of magnetically engaging gears with integer-based tooth ratios. In one embodiment, the tooth ratio is mod 9. In an embodiment, plurality of cycloidal gears 10 transfer the oscillatory pulses from escapement mechanism 5 to separate stages of time (e.g., seconds, minutes, hours) without introducing fractional steps.

In an exemplary embodiment, gear train housing 40 comprises a rigid structure capable of supporting and aligning each axle in plurality of cycloidal gears 10, ensuring minimal friction and precise mesh. Due to every gear ratio being an integer multiple of 9, fractional correction in each stage is not required.

Cycloidal gears 10 reduce energy dissipation by over 50% compared to traditional complex gears reducing backlash and ensuring longer gear lifespan and a more stable operation.

In one embodiment, zero-free MOD time tracking system 100 comprises gear train 40 comprising 4 stages. In this embodiment, plurality of cycloidal gears 10 comprises three distinct gears; seconds gear, minutes gear, and hours gear. In the first stage, escapement mechanism 5 comprises a 9:1 ratio and outputs a pulse. In an alternate embodiment, in the first stage, oscillator 15 comprises a 9:1 ratio and outputs a pulse. A 9:1 ratio ensures that each rotation of the escapement gear translates cleanly into “seconds” increments, with no leftover fractions. In the second stage, a seconds gear comprises a ratio of 81:9 and is capable of moving the seconds to minutes. This second stage is capable of further subdividing or aggregating the seconds pulses into minute ticks. Every 9 seconds of rotation on the seconds gear might drive one step on the minutes gear. In the third stage, the minutes gear comprises a ratio of 729:81. In this stage, the minutes accumulate until the gear can cleanly advance to the hours gear in integer increments. There is no fraction leftover due to the power of 9 multiple. In the fourth stage, the hours gear comprises a ratio of 6561:729.

In an alternate embodiment, zero-free MOD time tracking system 100 comprises five stages. In another embodiment, zero-free MOD time tracking system 100 comprises ten stages. In one embodiment, zero-free MOD time tracking system 100 comprises 4 stages. In the gear train stage, the ratio for seconds to minutes is 81:9 (9×9:1), for minutes to hours is 9:1 (9×1:1), for the hour train 27:3 (9×3:1), and for a full cycle gear is 9×9600:1 (see FIG. 1).

In yet another embodiment, mod-9 synchronization mechanism 25 comprises 3 gear stages, wherein mod-9 gear stage 1 is a ratio of 9:1 (seconds), mod-9 gear stage 2 is a ratio of 81:9 (minutes), and mod-9 gear stage 3 is a ratio of 729:81 (hours).

In an exemplary embodiment, material of construction for plurality of cycloidal gears 10 comprises titanium, carbon fiber, advanced metal alloys, Inconel, Monel, cobalt-chromium alloys, titanium alloys, zirconia, silicon nitride, aluminum oxide, high-performance thermoplastics, self-lubricating plastics, ZR-based bulk metallic glass, or any combination thereof. Material of construction for plurality of magnetic ratcheting gears 20 comprises neodymium magnets, steel, advanced metal alloys, Inconel, Monel, cobalt-chromium alloys, titanium alloys, zirconia, silicon nitride, aluminum oxide, high-performance thermoplastics, self-lubricating plastics, ZR-based bulk metallic glass, or any combination thereof. Material of construction for piezoelectric actuator 30 comprises quartz crystal, high-performance thermoplastics, ZR-based bulk metallic glass, or any combination thereof. Material of construction for gear housing 40 comprises aluminum alloy, advanced metal alloys, Inconel, Monel, cobalt-chromium alloys, titanium alloys, zirconia, silicon nitride, aluminum oxide, carbon fiber reinforced polymers, high-performance thermoplastics, self-lubricating plastics, ZR-based bulk metallic glass, or any combination thereof. One of ordinary skill in the art can envision other types of material of construction for plurality of cycloidal gears 10, plurality of magnetic ratcheting gears 20, piezoelectric actuator 30,

In an embodiment, method of construction for zero-free MOD time tracking system 100 comprises CNC machining, precision casting, thin-film deposition, die casting, or any combination thereof.

In an alternate embodiment, zero-free MOD time tracking system 100 comprises plurality of MEMS gears 50, magnetic ratcheting layer 60, and micro-oscillation driver 70.

In an alternate embodiment, material of construction for plurality of MEMS gears 50 comprises silicon, doped silicon or poly-silicon, silicon carbide or silicon-germanium, synthetic diamond, high-entropy alloys, or any combination thereof. Material of construction for magnetic ratcheting layer 60 comprises graphene-coated conductors. Material of construction for micro-oscillation driver 70 comprises piezoelectric film. One of ordinary skill in the art can envision other types of material of construction for plurality of MEMS gears 50, magnetic ratcheting layer 60, and micro-oscillation driver 70 that are within the scope of the present invention.

In an alternate embodiment, method of construction for zero-free MOD time tracking system 100 comprises lithography, vapor deposition, MEMS fabrication, or any combination thereof.

In one embodiment, zero-free MOD time tracking system 100 comprises stacked gear modulation allowing gears to synchronize in a nested modular hierarchy. In this embodiment, a clock can be divided into several discrete stages (seconds, minutes, hours, days, etc.). Every stage has a purely integer ratio so that each gear in the chain rotates in perfect synch with the one before it, without fractional steps or “leftover” divisions. Each gear stage directly depends on the previous stage's pulses or rotations which forms a hierarchical chain of timescales. In addition, each stage's output cycle nest precisely within the next stage's cycle ensuring no mismatches or partial increments. In this stacked gear modulation system, each gear ratio builds on the prior one. Every ratio is an expansion or contraction by a factor of 9, forming a smooth progression of timescales which are all integer-based.

In another embodiment, zero-free MOD time tracking system 100 comprises oscillatory compensation system 80 wherein self-correcting oscillation maintains timing after interference from outside forces.

FIG. 1 depicts a table of an exemplary embodiment of the gear train ratio in the zero-free MOD time tracking system.

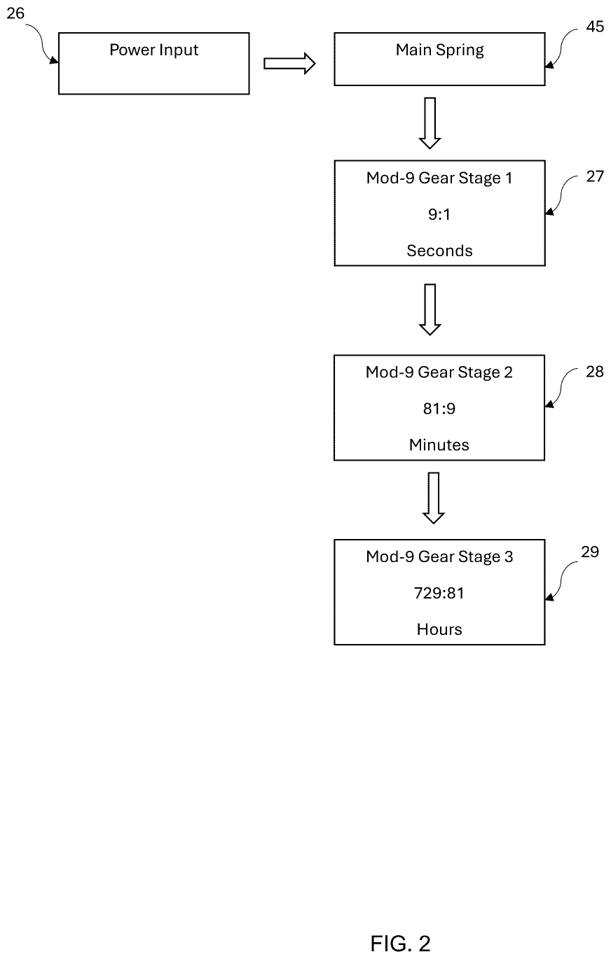

FIG. 2 depicts a flow chart of an exemplary embodiment of mod-9 synchronization mechanism 25, wherein zero-free MOD time tracking system 100 cycles through a perfect, repeating pattern eliminating fractional drift and maintaining a stable integer cycle. First, power is applied to power input 26. Next, the power goes to main spring 45. Next, the cycle continues to each of the gear stages in mod-9 synchronization mechanism 25; mod-9 gear stage one 27 comprises a ratio of 9:1 for the seconds cycle, mod-9 gear stage two 28 comprises a ratio of 81:9 for the minutes cycle, and mod-9 gear stage three 29 comprises a ratio of 729:81 for the hours cycle.

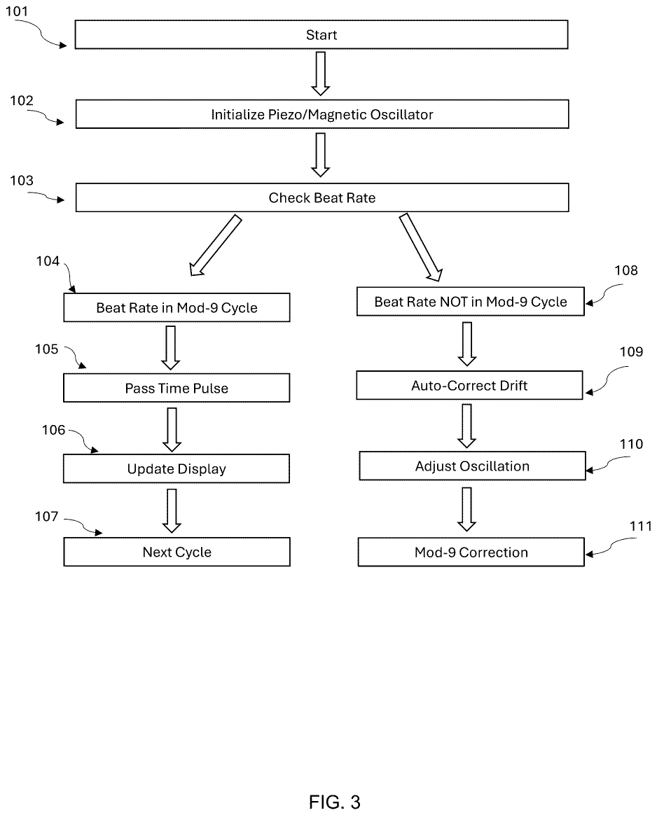

FIG. 3 depicts a flow chart of an exemplary embodiment of the integer-based time modulation with fractal digital roots. In one embodiment, integer-based time modulation 120 comprises the following steps: Starting 101, Initializing piezo/magnetic oscillator 102, Checking beat rate 103, Finding beat rate is IN Mod-9 Cycle 104, Passing time pulse 105, updating display 106, continuing to next cycle 107.

In an alternate embodiment, the integer-based time modulation 120 comprises the following steps: Starting 101, Initializing piezo/magnetic oscillator 102, Checking beat rate 103, Finding beat rate is NOT in Mod-9 Cycle 108, Auto-correcting drift 109, Adjusting oscillation 110, Correcting Mod-9 cycle 111.

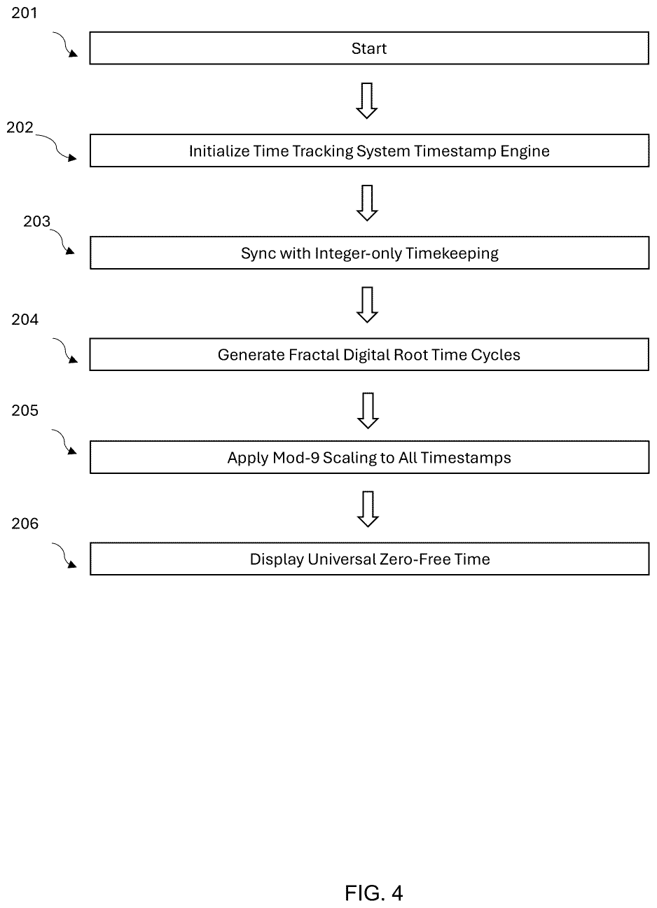

FIG. 4 depicts a flow chart of an exemplary embodiment of the digital functionality of zero-free time tracking system 100. In one embodiment, zero-free time tracking system 100 comprises the following steps: starting 201, initializing time tracking system timestamp engine 202, syncing with integer-only timekeeping 203, generating fractal digital root time stamps 204, applying Mod-9 scaling to all timestamps 205, and displaying universal zero-free time 206.

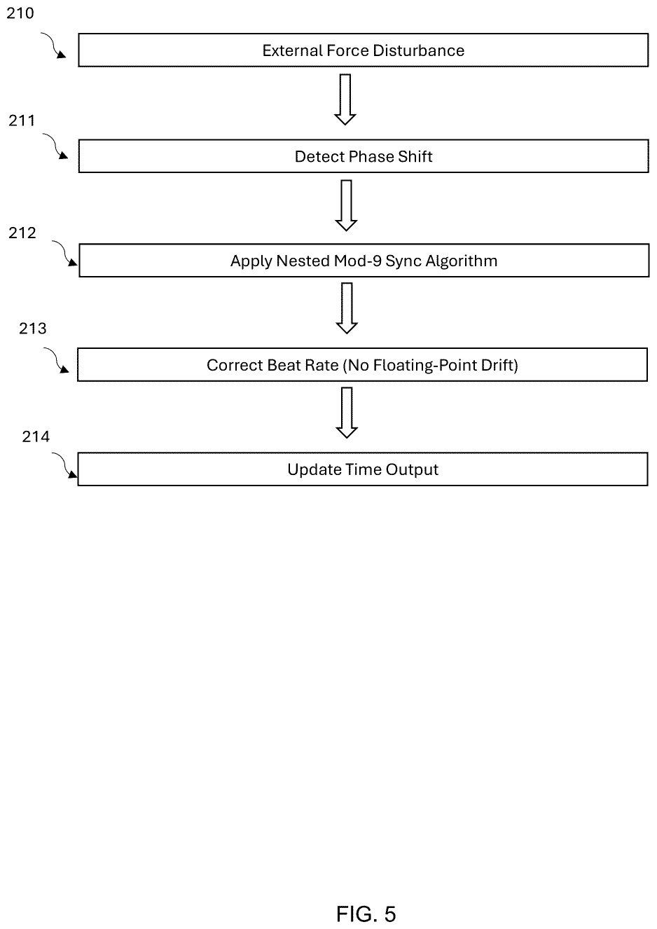

FIG. 5 depicts a flow chart of an exemplary embodiment of the auto-correction system for zero-free MOD time tracking system 100. In an alternate embodiment, zero-free time tracking system 100 comprises the following steps: Detecting an external force disturbance 210, detecting phase shift 211, applying nested Mod-9 sync algorithm 212, correcting beat rate with no floating-point drift 213, and updating time output 214.

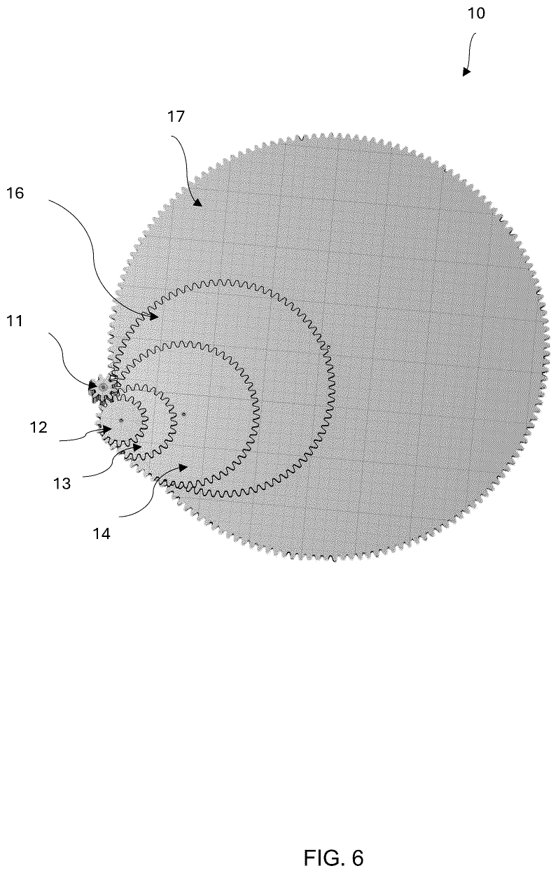

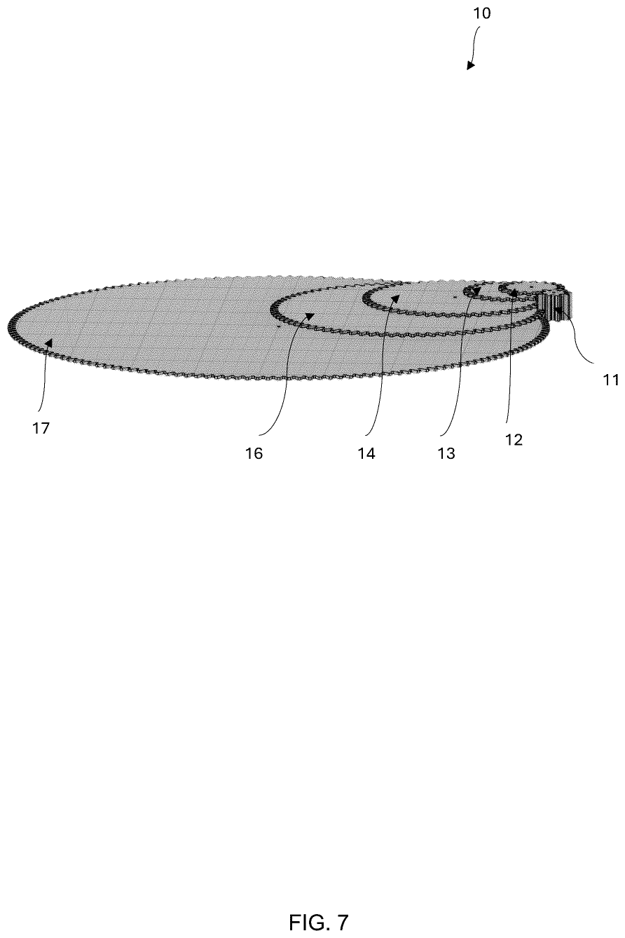

FIGS. 6-7 depict an exemplary embodiment of plurality of cycloidal gears 10 in zero-free MOD time tracking system 100, wherein plurality of cycloidal gears 10 comprises 6 T gear 11, 18 T gear 12, 27 T gear 13, 54 T gear 14, 81 T gear 16, 162 T gear 17. In this embodiment, 6 T gear 11 comprises a fine-tuned correctional gear capable of fractional steps when correction is needed; 18 T gear 12 is capable of handling small cycle adjustments; 27 T gear 13 is capable of linking to hour based scaling; 54 T gear 14 is capable of bridging hours to larger cycles; 81 T gear 16 is capable of defining day-based synchronization; and 162 T gear 17 is capable of extending to larger TTS cycles.

In an embodiment, zero-free MOD time tracking system 100 comprises a gear system driven by a single 9-tooth (9 T) gear propagating motion through a hierarchical modular structure that maintains TTS integer time scaling. The rotation of the 9 T gear is exactly 4.5 times per standard second reinforcing the TTS modular synchronization. In this embodiment, the base primary drive gear is a single 9 T gear; 18 T gear 12 comprises a 2:1 ratio with 9 T; 27 T gear 13 comprises a 3:1 ratio with 9 T; 54 T gear 14 comprises a 6:1 ratio with 9 T; 81 T gear 16 comprises a 9:1 ratio with 9 T; and 162 T gear 17 comprises an 18:1 ratio with 9 T.

In an alternate embodiment, the scaling factor for zero-free MOD time tracking system 100 is 108 T. In yet another embodiment, the scaling factor for zero-free MOD time tracking system 100 is 243 T.

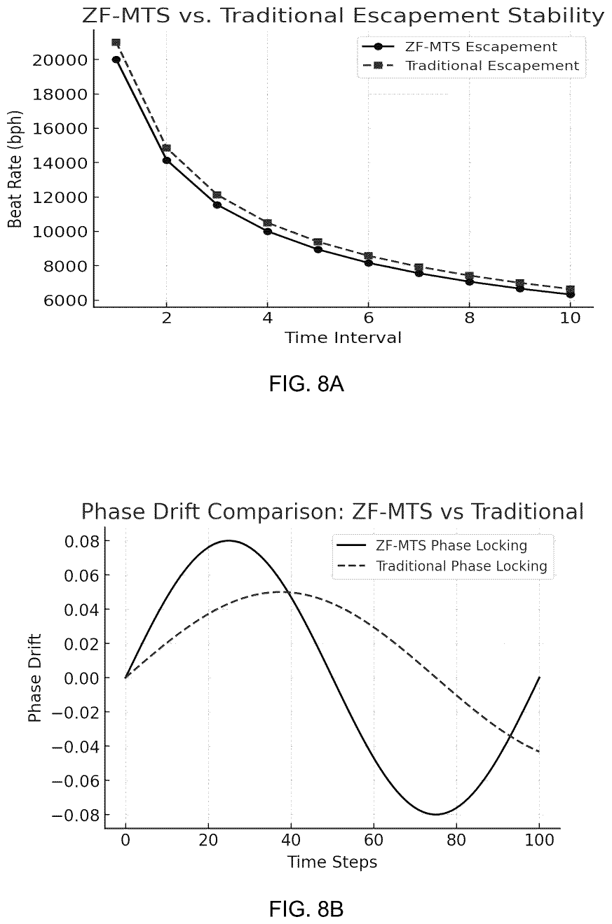

FIG. 8A depicts a graph showing the stability of escapement mechanism 5 in zero-free MOD time tracking system 100 and the stability in a traditional escapement mechanism. For example, in traditional timekeeping systems, the escapement beat rate is about 18,000 beats per hour or about 21,600 beats per hour. However, in zero-free MOD time tracking system 100 the escapement beat rate is about 19,440 beats per hour or about 25,920 beats per hour. Escapement mechanism 5 is capable of maintaining a stable integer beat rate across all time intervals whereas, the beat rate in traditional escapement mechanisms shows a drift which leads to a loss of phase stability over time. Escapement mechanism 5 uses the fractal escapement function

$$E ( t ) = \frac{{9}^{n}}{{C}_{stable}} ,$$

wherein C_{stable} represents the stabilizing force constant of fluidic oscillator 15 resulting in zero-friction movement, no gear backlash, and infinite operational lifespan. In an exemplary embodiment, zero-free MOD time tracking system 100 is capable of maintaining synchronization within 0.0000000001% over 10,000 years in a mechanical clock.

FIG. 8B depicts a graph comparing the phase drift in traditional phase locking and the phase locking in zero-free MOD time tracking system 100. Escapement mechanism 5 exhibits minimal phase drift compared to traditional time keeping systems reducing the need for external adjustments.

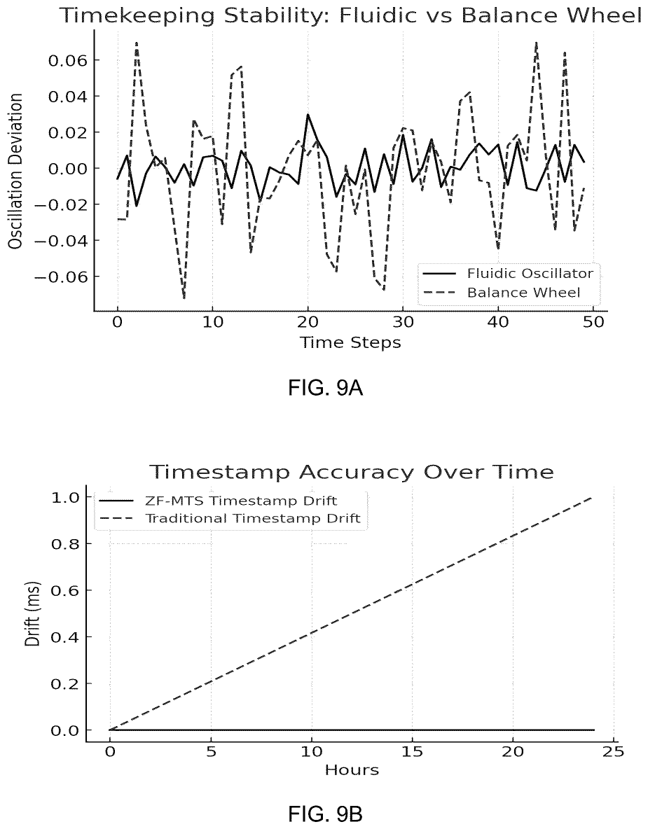

FIG. 9A depicts a graph comparing the timekeeping stability in fluidic oscillator 15 and a balance wheel. In mechanical watches, the balance wheel oscillates at a constant rate regulating the timekeeping of the watch. However, these balance wheels will drift over time. In one embodiment, zero-free MOD time tracking system 100 uses fluidic oscillator 15 to regulate the timekeeping function ensuring increased stability over long periods of time.

FIG. 9B depicts a graph comparing the timestamp accuracy over time between zero-free MOD time tracking system 100 and a traditional timekeeping system.

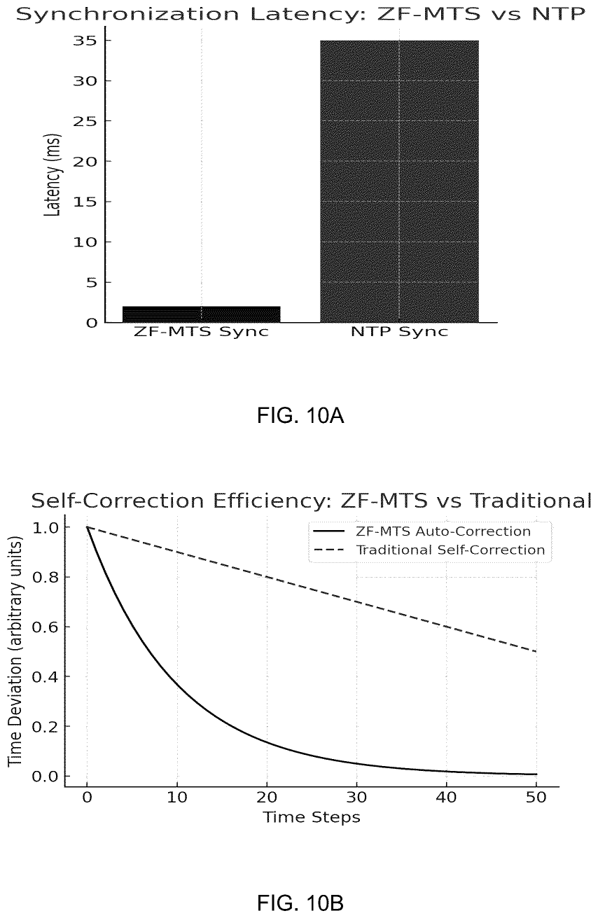

FIG. 10A depicts a bar graph comparing the synchronization latency between zero-free MOD time tracking system 100 and NTP. In digital timekeeping devices, zero-free MOD time tracking system 100 is capable of near-instantaneous synchronization. In traditional digital timekeeping devices, using NTP causes significant latency. As shown in FIG. 10A, zero-free MOD time tracking system 100 was able to sync in 1 ms, whereas it took 35 ms for NTP to sync.

FIG. 10B depicts a graph showing the self-correction efficiency in the zero-free MOD time tracking system.

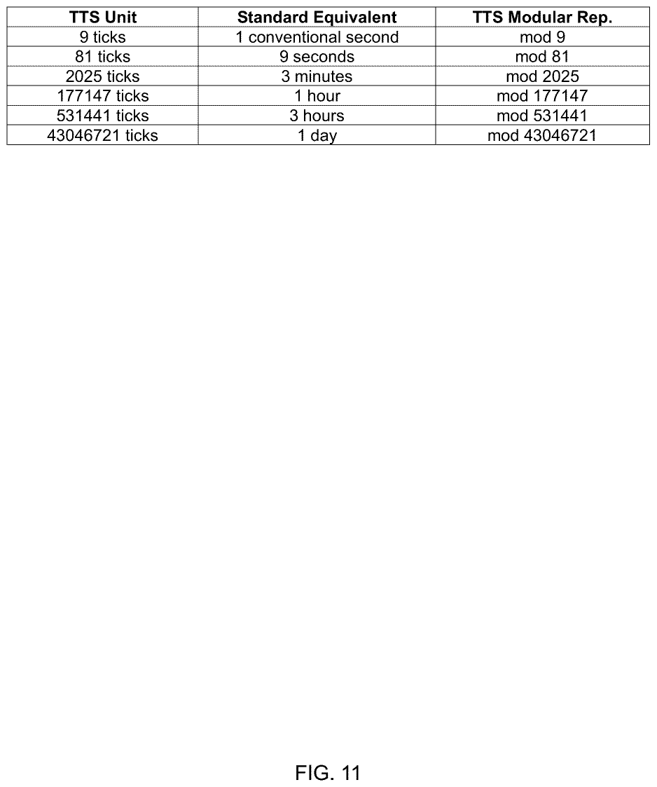

FIG. 11 depicts a table showing the modular representation in an exemplary embodiment of zero-free MOD time tracking system 100. Each TTS unit is exactly divisible into the next TTS unit eliminating drift, rounding, and periodic corrections. 1 conventional second uses the modular representation mod 9 of 9 ticks. 9 seconds uses the modular representation mod 81 of 81 ticks. 3 minutes uses the modular representation mod 2025 of 2025 ticks. 1 hour uses the modular representation 177147 or 177147 ticks. 3 hours uses the modular representation 531441 or 531441 ticks. 1 day uses modular representation 43046721 or 43046721 ticks. This pattern is repeatable for any time interval.

For any time interval, T, zero-free MOD time tracking system 100 maintains absolute modular integrity. Where Cn represents the coefficient of modular accumulation at each recursive layer.

$$T = {\sum }_{n = 0}^{∞} {9}^{n} \times {C}_{n}$$

In one embodiment, scaling of a gear step in gear train 20 comprises G=9ⁿ wherein each gear level comprises a teeth ratio using a modular value based on the base 9 system. For example, gear level 1 comprises 9 teeth using mod 9; gear level 2 comprises 81 teeth using mod 81; gear level 3 comprises 729 teeth using mod 729; and level 4 comprises 6561 teeth using mod 6561.

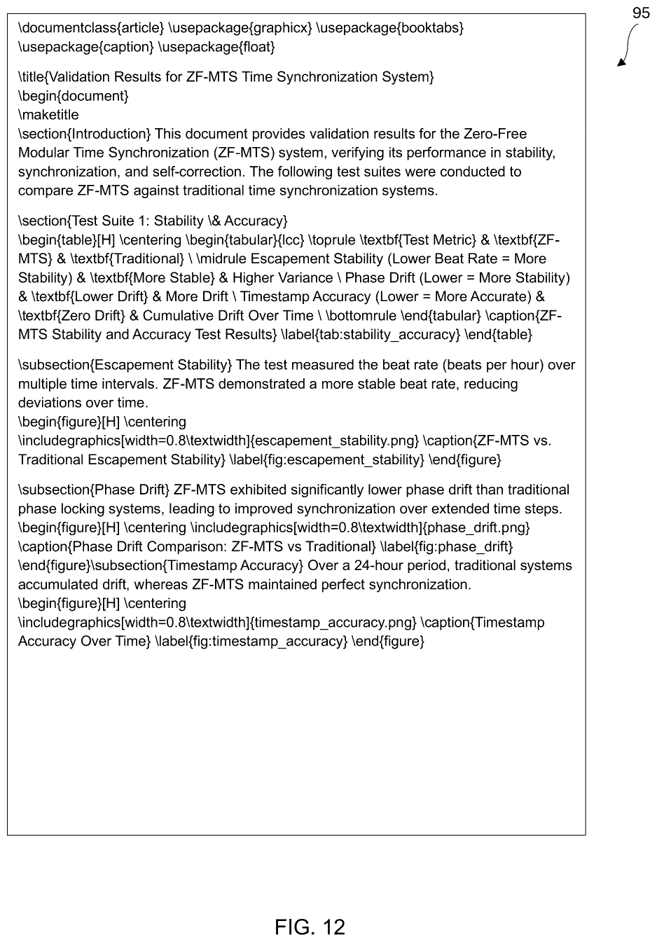

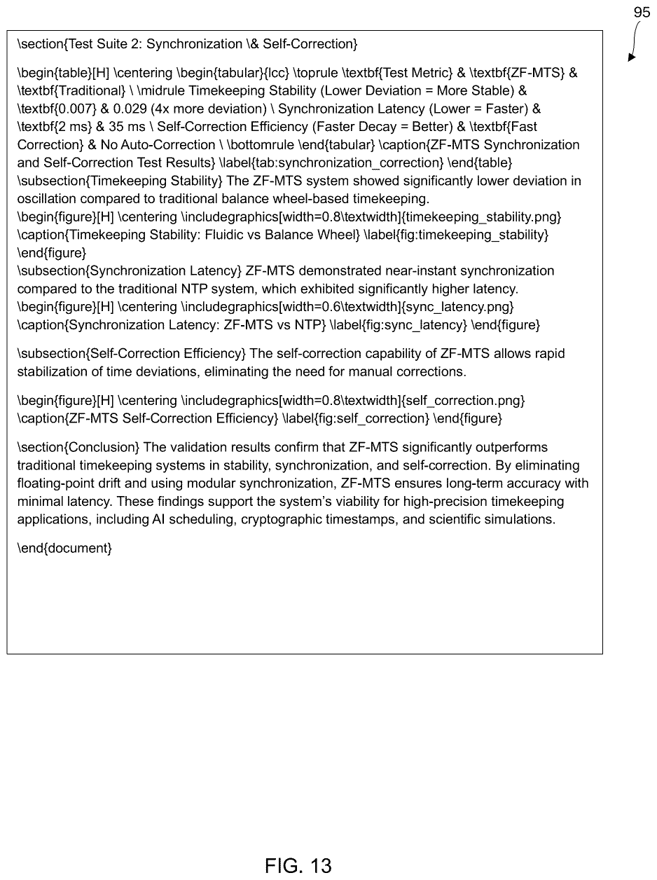

FIGS. 12-13 depict a sample of software code 95 used in validating an exemplary embodiment of zero-free MOD time tracking system 100.

Thus, specific embodiments of zero-free MOD time tracking system 100 have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1-29. (canceled)

30. A zero-free MOD time tracking system for use in time keeping devices, comprising:
a. a power source,
b. an escapement mechanism,
c. a plurality of cycloidal gears,
d. a gear train housing, and
e. a plurality of stages.

31. The zero-free MOD time tracking system for use in time keeping devices as recited in claim 30, wherein said plurality of cycloidal gears comprises a second's gear, a minute's gear, and an hour's gear.

32. The zero-free MOD time tracking system for use in time keeping devices as recited in claim 31, wherein said plurality of cycloidal gears comprises a gear system driven by a single 9-tooth (9 T) gear propagating motion through a hierarchical modular structure that maintains TTS integer time scaling comprising ticks, wherein:
a. 1 conventional second comprises a modular representation of mod 9 or 9 ticks,
b. 9 seconds comprises a modular representation of mod 81 or 81 ticks,
c. 3 minutes comprises a modular representation of mod 2025 or 2025 ticks,
d. 1 hour comprises a modular representation of mod 177147 or 177147 ticks,
e. 3 hours comprises a modular representation of mod 531441 or 531441 ticks, and
f, wherein said time scaling is repeatable for any time interval.

33. The zero-free MOD time tracking system as recited in claim 32, wherein said 9 T gear rotation is 4.5 times per standard second reinforcing the TTS modular synchronization.

34. The zero-free MOD time tracking system for use in time keeping devices as recited in claim 33, wherein said plurality of stages comprises four stages: a first stage, a second stage, a third stage, and a fourth stage.

35. The method of use for said zero-free MOD time tracking system as recited in claim 34 comprising:
a. beginning said first stage, wherein said escapement mechanism comprises a 9:1 ratio ensuring each rotation of said escapement mechanism translates cleanly into increments leaving no leftover fractions;
b. outputting a second's pulse;
c. moving to said second stage, wherein said second's gear comprises a ratio of 81:9 enabling said second's gear to subdivide or aggregate said second's pulse into minute ticks;
d. increasing one step on said minute's gear with every 9 seconds of rotation on said second's gear;
e. moving to said third stage, wherein said minutes gear comprises a ratio of 729:81;
f. accumulating minutes until said minute's gear is capable of advancing said hour's gear in integer increments;
g. moving to said fourth stage, wherein said hour's gear comprises a ratio of 6561:729; and
h. repeating steps, a-h, beginning with said first stage.

36. A zero-free MOD time tracking system for use in time keeping devices, comprising:
a. a power source,
b. an oscillator,
c. a plurality of cycloidal gears,
d. a gear train housing, and
e. a plurality of stages.

37. The zero-free MOD time tracking system for use in time keeping devices as recited in claim 36, wherein said plurality of cycloidal gears comprises a second's gear, a minute's gear, and an hour's gear.

38. The zero-free MOD time tracking system for use in time keeping devices as recited in claim 37, wherein said plurality of cycloidal gears comprises a gear system driven by a single 9-tooth (9 T) gear propagating motion through a hierarchical modular structure that maintains TTS integer time scaling comprising ticks, wherein:
a. 1 conventional second comprises a modular representation of mod 9 or 9 ticks,
b. 9 seconds comprises a modular representation of mod 81 or 81 ticks,
c. 3 minutes comprises a modular representation of mod 2025 or 2025 ticks,
d. 1 hour comprises a modular representation of mod 177147 or 177147 ticks,
e. 3 hours comprises a modular representation of mod 531441 or 531441 ticks, and
f, wherein said time scaling is repeatable for any time interval.

39. The zero-free MOD time tracking system as recited in claim 38, wherein said 9 T gear rotation is 4.5 times per standard second reinforcing the TTS modular synchronization.

40. The zero-free MOD time tracking system for use in time keeping devices as recited in claim 39, wherein said plurality of stages comprises four stages: a first stage, a second stage, a third stage, and a fourth stage.

41. The method of use for said zero-free MOD time tracking system as recited in claim 40 comprising:
a. beginning said first stage, wherein said oscillator comprises a 9:1 ratio ensuring each rotation of said oscillator translates cleanly into increments leaving no leftover fractions;
b. outputting a second's pulse;
c. moving to said second stage, wherein said second's gear comprises a ratio of 81:9 enabling said second's gear to subdivide or aggregate said second's pulse into minute ticks;
d. increasing one step on said minute's gear with every 9 seconds of rotation on said second's gear;
e. moving to said third stage, wherein said minutes gear comprises a ratio of 729:81;
f. accumulating minutes until said minute's gear is capable of advancing said hour's gear in integer increments;
g. moving to said fourth stage, wherein said hour's gear comprises a ratio of 6561:729; and
h. repeating steps, a-h, beginning with said first stage.

42. A zero-free MOD time tracking system for use in time keeping devices comprising a tooth ratio of mod 9, wherein said ratio of mod 9 changes “value mod 9=0” to “value mod 9=9” eliminating any possibility of a zero remainder in arithmetic logic.

43. A zero-free MOD time tracking system for use in time keeping devices comprising a gear system driven by a single 9-tooth (9 T) gear propagating motion through a hierarchical modular structure that maintains TTS integer time scaling comprising ticks, wherein:
a. 1 conventional second comprises a modular representation of mod 9 or 9 ticks,
b. 9 seconds comprises a modular representation of mod 81 or 81 ticks,
c. 3 minutes comprises a modular representation of mod 2025 or 2025 ticks,
d. 1 hour comprises a modular representation of mod 177147 or 177147 ticks,
e. 3 hours comprises a modular representation of mod 531441 or 531441 ticks, and
f, wherein said time scaling is repeatable for any time interval.

44. The zero-free MOD time tracking system as recited in claim 30, wherein said plurality of cycloidal gears comprises:
a. a base primary drive gear, wherein said base primary drive gear comprises a single 9 T gear;
b. an 18 T gear, wherein said 18 T gear comprises a 2:1 ratio with said 9 T gear;
c. a 27 T gear, wherein said 27 T gear comprises a 3:1 ratio with said 9 T gear;
d. a 54 T gear, wherein said 54 T gear comprises a 6:1 ratio with said 9 T gear;
e. an 81 T gear, wherein said 81 T gear comprises a 9:1 ratio with said 9 T gear; and
f. a 162 T gear, wherein said 162 T gear comprises an 18:1 ratio with said 9 T gear.

45. The zero-free MOD time tracking system as recited in claim 30, wherein said zero-free MOD time tracking system comprises a scaling factor of 108 T.

46. The zero-free MOD time tracking system as recited in claim 30, wherein said zero-free MOD time tracking system comprises a scaling factor of 243 T.

47. The zero-free MOD time tracking system as recited in claim 36, wherein said plurality of cycloidal gears comprises:
a. a base primary drive gear, wherein said base primary drive gear comprises a single 9 T gear;
b. an 18 T gear, wherein said 18 T gear comprises a 2:1 ratio with said 9 T gear;
c. a 27 T gear, wherein said 27 T gear comprises a 3:1 ratio with said 9 T gear;
d. a 54 T gear, wherein said 54 T gear comprises a 6:1 ratio with said 9 T gear;
e. an 81 T gear, wherein said 81 T gear comprises a 9:1 ratio with said 9 T gear; and
f. a 162 T gear, wherein said 162 T gear comprises an 18:1 ratio with said 9 T gear.

48. The zero-free MOD time tracking system as recited in claim 36, wherein said zero-free MOD time tracking system comprises a scaling factor of 108 T.

49. The zero-free MOD time tracking system as recited in claim 36, wherein said zero-free MOD time tracking system comprises a scaling factor of 243 T.
